(19) United States
(12) Patent Application Publication
(10) Pub. No.: US 2016/0122010 A1
(43) Pub. Date: May 5, 2016

(54) AERIAL VEHICLE

(71) Applicant: HON HAI PRECISION INDUSTRY CO., LTD., New Taipei (TW)

(72) Inventor: PEI-CHONG TANG, New Taipei (TW)

(21) Appl. No.: 14/752,385

(22) Filed: Jun. 26, 2015

(30) Foreign Application Priority Data
Oct. 31, 2014 (CN) 201410598843.6

(51) Int. Cl. B64C 27/08; G01C 19/02; B64C 39/02; B64D 45/00

(52) U.S. Cl. CPC B64C 27/08; B64D 45/00; G01C 19/02; B64C 39/024

(57) ABSTRACT

An aerial vehicle includes a body, a plurality of rotors coupled to the body and configured to provide lift, a plurality of driving devices coupled to the rotors respectively and configured to drive the rotors to rotate, and a control device coupled to the body and the driving devices. The control device includes a gyroscope and a controller. The gyroscope is configured to collect information of rotation speed of the body and transmit the information of the rotation speed to the controller. The controller is configured to provide a driving power for adjusting the rotation speed of the body according the information of the rotation speed, and produce and transmit a control signal of the driving power to the driving devices to output the driving power to corresponding rotors to adjust the rotation speed of the body.

### FIELD

The subject matter herein generally relates to aerial vehicles, particularly relates to a helicopter rotor type aerial vehicle.

### BACKGROUND

Unmanned aerial vehicles are wildly used for aerial photography, atmospheric observations, military reconnaissance, danger detections and other fields. The aerial vehicle controls its flight attitude by controlling rotation speed of a plurality of rotors thereof. The aerial vehicle can be a quad-rotor aerial vehicle, a six-rotor aerial vehicle, an eight-rotor aerial vehicle, or others. The rotors are mounted on a vertical mechanism to provide vertical lift to the aerial vehicle.

### BRIEF DESCRIPTION OF THE DRAWINGS

Implementations of the present technology will now be described, by way of example only, with reference to the attached figures.

FIG. 1 is an isometric view of an aerial vehicle in accordance with an embodiment of the present disclosure.

FIG. 2 is a diagrammatic view of a control device of the aerial vehicle of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to an aerial vehicle. The aerial vehicle can include a body, a plurality of rotors coupled to the body and configured to provide lift, a plurality of driving devices coupled to the rotors respectively and configured to drive the rotors to rotate, and a control device coupled to the body and the driving devices. The control device can include a gyroscope and a controller. The gyroscope is configured to collect information of rotation speed of the body and transmit the information of the rotation speed to the controller. The controller is configured to provide a driving power for adjusting the rotation speed of the body according the information of the rotation speed, and to produce and transmit a control signal of the driving power to the driving devices to output the driving power to corresponding rotors to adjust the rotation speed of the body.

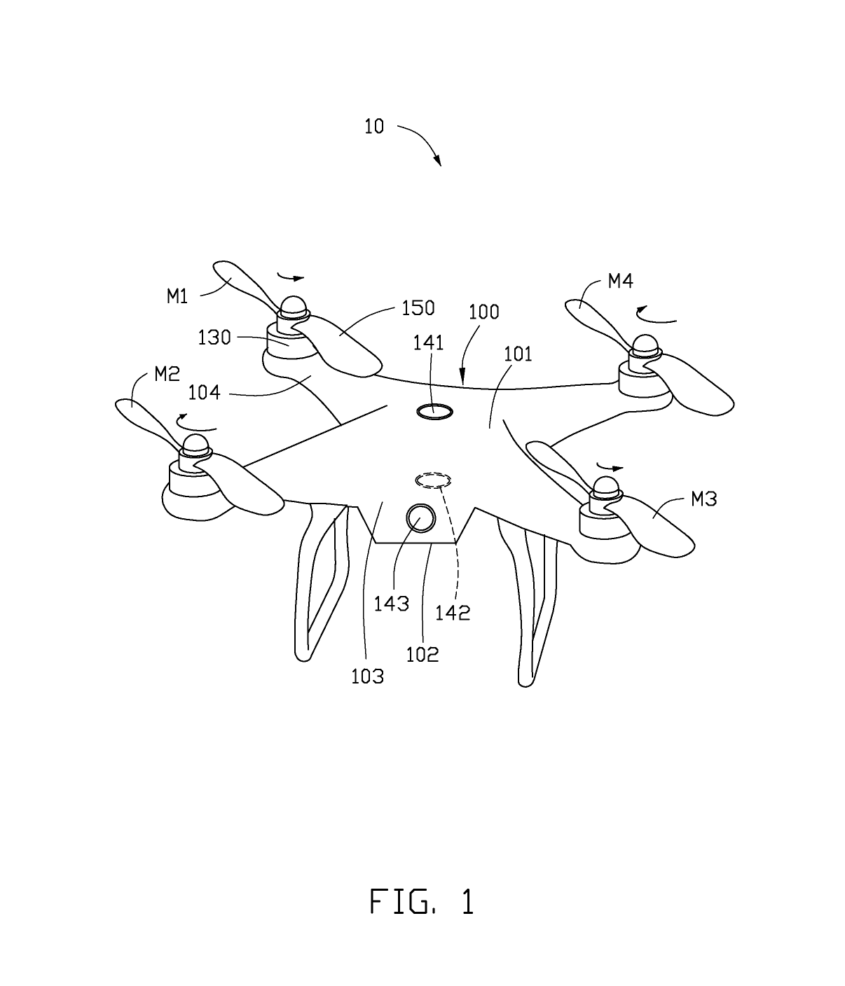

FIG. 1 illustrates an aerial vehicle 10 of an embodiment of the present disclosure. The aerial vehicle 10 can include a body 100, a plurality of arms 104 coupled to the body 100, a plurality of rotors 150 coupled to the arms 104 for lifting and controlling rotation states of the aerial vehicle 10, a plurality of driving devices 130 coupled to the rotors 150, and a control device 105 coupled to the body 100.

In this embodiment, the aerial vehicle 10 is shown as a quad-rotor aerial vehicle, just for taking an example for illustrating a configuration of the aerial vehicle, the aerial vehicle also can be a six-rotor aerial vehicle, an eight-rotor aerial vehicle, or others. In this embodiment, the aerial vehicle includes four arms 104, four rotors 150 and four driving devices 130. The four arms 104 extend outwardly from the body 100. The four arms 104 can be symmetrical to each other about the body 100. The four rotors 150 and the four driving devices 130 are mounted to the four arms 104. The driving devices 130 can be driving motors. The control device 105 is mounted in the body 100.

In at least one embodiment, the aerial vehicle 10 can further include a carrier under the body 100 for carrying payload such as a camera.

The body 100 can include a ceiling portion 101, a bottom portion 102 opposite to the ceiling portion 101 and a lateral portion 103 connecting the ceiling portion 101 and the bottom portion 102. The four arms 104 extend outwards from the lateral portion 103. In at least one embodiment, the four arms 104 can integrally extend outwards from the lateral portion 103. The four driving devices 130 are mounted at distal ends of the arms 104, respectively. The four rotors 150 are located above and connecting the four driving devices 130, respectively. Each driving device 130 is located between a corresponding arm 104 and a corresponding rotor 150. Each rotor 150 can be independently controlled by a corresponding driving device 130. The driving device 130 is configured to provide power to drive the corresponding rotor 150 to rotate. By adjusting rotation speeds of the rotors 150, the aerial vehicle 10 can realize flight attitudes of lifting, landing, level flight, level rotation, heeling, hovering and others.

The four rotors 150 are divided into a first unit and a second unit, the two rotors 150 at a diagonal line are belong to the first unit, the other two rotors 150 at another diagonal line are belong to the second unit. The rotors 150 of the first unit can rotate along a first direction. The rotors 150 of the second unit can rotate along a second direction counter to the first direction. By adjusting rotation speeds of the rotors 150 of the first unit and the second unit, the aerial vehicle 10 can realize flight attitudes of lifting, landing, level flight, level rotation, heeling, hovering and others. In at least one embodiment, as illustrated in FIG. 1, the four rotors 150 are labeled as M1, M2, M3 and M4 along anticlockwise direction, wherein, the rotors M1 and M3 are belong to the first unit and can rotate anticlockwise, the rotors M2 and M4 are belong to the second unit and can rotate clockwise.

When increasing same rotation speeds to the four rotors 150 by increasing same output power of the four driving devices 130, lift provided by the four rotors 150 increases, the aerial vehicle 10 vertically uplift when the lift in a vertical direction is larger than the gravity of the aerial vehicle 10. Conversely, when decreasing same rotation speeds to the four rotors 150 by decreasing same output power of the four driving devices 130, the lift provided by the four rotors 150 decreases, the aerial vehicle 10 vertically drops and lands when the lift in the vertical direction is less than the gravity of the aerial vehicle 10. When the lift in the vertical direction is equal to the gravity of the aerial vehicle 10, the aerial vehicle 10 can be hovering.

In at least one embodiment, when the aerial vehicle 10 is hovering, the aerial vehicle 10 can rotate in a horizontal plane where the aerial vehicle 10 is hovering. Here, the rotors 150 of the first unit each have a same first rotation speed. The rotors 150 of the second unit each have a same second rotation speed. In detail, the rotor M1 of the first unit has the first rotation speed same as that of the rotor M3 of the first unit along the anticlockwise direction. The rotor M2 of the second unit has the second rotation speed same as that of the rotor M4 of the second unit along the clockwise direction. The first rotation speed of rotors 150 of the first unit is different from the second rotation speed of rotors 150 of the second unit. The first rotation speed and the second rotation speed of the rotors 150 are constant. When the first rotation speed along the anticlockwise direction is larger than the second rotation speed along the clockwise direction, the body 100 of the aerial vehicle can rotate clockwise. Conversely, when the first rotation speed along the anticlockwise direction is less than the second rotation speed along the clockwise direction, the body 100 of the aerial vehicle can rotate anticlockwise.

In at least one embodiment, when one rotor 150 of the first unit has a first rotation speed equal to that of one rotor 150 of the second unit, the other rotor 150 of the first unit has a second rotation speed equal to that of the other rotor 150 of the second unit, and the first rotation speed is different from the second speed, the aerial vehicle 10 can levelly fly. In details, when the rotor M1 of the first unit has the first rotation speed equal to that of the rotor M2 of the second unit, the rotor M3 of the first unit has the second rotation speed equal to that of the rotor M4, the first rotation speed of the rotors M1, M2 is different from the second speed of the rotors M3, M4, the aerial vehicle 10 can levelly fly forwards or backwards. When the rotor M1 of the first unit has the first rotation speed equal to that of the rotor M4 of the second unit, the rotor M3 of the first unit has the second rotation speed equal to that of the rotor M2, the first rotation speed of the rotors M1, M4 is different from the second speed of the rotors M3, M2, the aerial vehicle 10 can left or right at substantially constant level.

In at least one embodiment, when the rotation speed of the rotors 150 of the first unit is the same, the rotation speed of the rotors 150 of the second unit is the same, the aerial vehicle 10 can hover. When the rotation speed of the rotors 150 of the first unit is same as the rotation speed of the rotors 150 of the second unit, the body 100 of the aerial vehicle 10 can hover without movement. When the rotation speed of the rotors 150 of the first unit or the second unit is varied, so that the rotation speed of the rotors 150 of the first unit is different from the rotation speed of the rotors 150 of the second unit, the body 100 of the aerial vehicle 10 can hover with level rotation.

In other embodiment, the number of the arms 104 can be six, eight or others, correspondingly, the number of the rotors 150 at the distal ends of the arms 104 can be six, eight or others. The aerial vehicles with these numbers of arms 104 and rotors 150 have working principle substantially same as that of the aerial vehicle 10 with four arms 104 and four rotors 150.

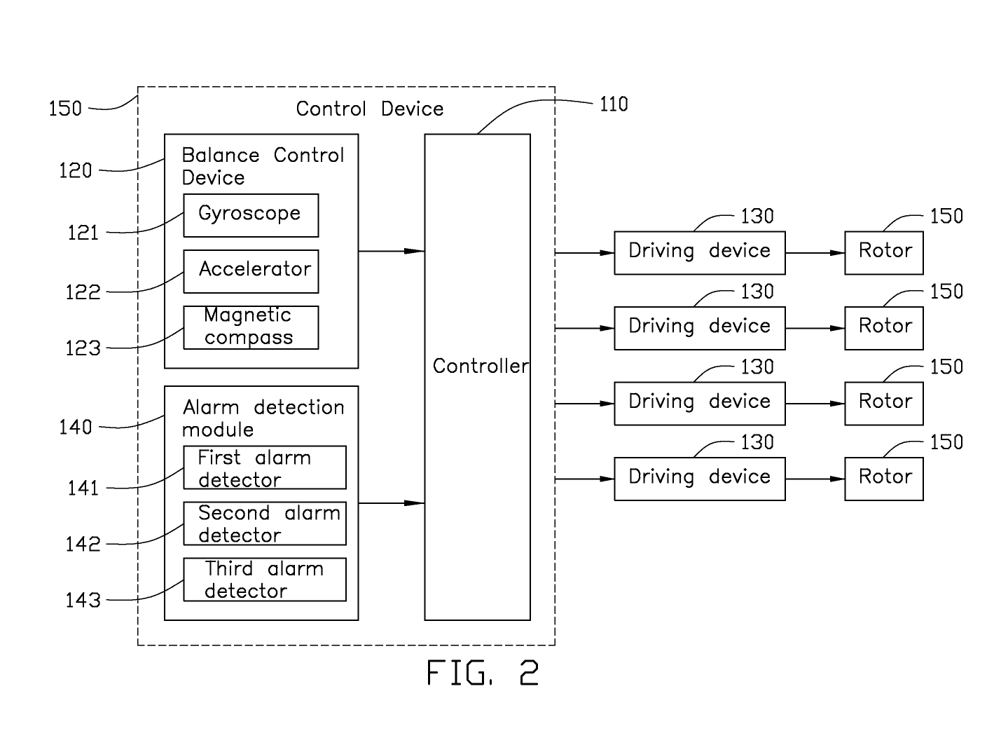

FIG. 2 illustrates the control device 105 of the aerial vehicle 10. The control device 105 is configured to control the driving devices 130 to adjust rotation speed of the rotors 150. The control device 105 can include a controller 110, a balance control device 120 and an alarm detection module 140. The controller 110, the balance control device 120 and the alarm detection module 140 are coupled to the body 100.

The balance control device 120 is configured to maintain balance of the body 100. The balance control device 120 can include a gyroscope 121, accelerator 122 and a magnetic compass 123. The gyroscope 121 is configured to collect information of rotation speed of the body 100, for control the rotation speed of the body 100 in flight. The accelerator 122 is configured to measure accelerated velocity of the body 100 in flight for stabling balance of the body 100. The magnetic compass 123 is configured to measure geomagnetic angle for marking nose direction of the aerial vehicle 10.

The gyroscope 121 is configured to control the rotation speed of the body 100 in flight. In flight, due to unbalance of angular force or balance of angular force, the body 100 rotates or holds still without rotation, the gyroscope 121 will collect the information of rotation speed of the body 100, and transmits the information of the rotation speed to the controller 110. The controller 110 works out a driving power for adjusting the rotation speed of the body 100 according the information of the rotation speed, produces a control signal, and transmits the control signal to the driving device 130. According to the control signal, the driving device 130 outputs the driving power to drive the rotors 150 to rotate, therefore, the rotation speed of the body 100 are adjusted. Rotation of the rotors 150 provides lift to the aerial vehicle 10, and controls attitudes of movement of the aerial vehicle 10 and the rotation speed of the body 100. Wherein, the controller 110 outputs four control signals to corresponding driving devices 130.

In at least one embodiment, the gyroscope 121 controls the body 100 to rotate along a vertical direction at a preset rotation speed, which can avoid the body 100 rotating irregularly or holding still. In at least one embodiment, the rotation speed of the body 100 is much less than the rotation speed of the rotors 150, the rotations of the body 100 can be distinguished macroscopicly.

The alarm detection module 140 is configured to detect abnormal conditions around the aerial vehicle 10. The alarm detection module 140 can include a plurality of alarm detectors coupled portions of the aerial vehicle 10. In at least one embodiment, the plurality of alarm detectors can include a first alarm detector 141 coupled to the ceiling portion 101 of the body 100, a second alarm detector 142 coupled to bottom portion 102 of the body 100, and a third alarm detector 143 coupled to the lateral portion 103 of the body 100. The first alarm detector 141 coupled to the ceiling portion 101 is configured to detect a region above the ceiling portion 103. The second alarm detector 142 is configured to detect a region below the bottom portion 103. The third alarm detector 143 is configured to detect a region before the lateral portion 103. When the aerial vehicle 10 is hovering, the body 100 rotates, the third alarm detector 143 rotates following rotation of the body 100, therefore, the third alarm detector 143 can realize 360-degrees detection to detect abnormal conditions in the region around the lateral portion 103. When the alarm detection module 140 detects that the aerial vehicle 10 is adjacent to a foreign matter, the alarm detection module 140 outputs alarm signals to the controller 110, the controller 110 outputs control signal to the driving device 130, the driving device 130 adjusts rotation speed of the rotors 150 to change flight route of the aerial vehicle 10 to move away from the foreign matter.

In at least one embodiment, during rotation of the body 100, the magnetic compass 123 rotates following the rotation of the body 100, the magnetic compass 123 detects and marks angles of the foreign matter.

In at least one embodiment, the body 100 can rotate intermittently or with a preset rotation angle. When the body 100 rotates along the vertical direction with a preset rotation angle, a number of the third alarm detector 143 coupled to the lateral portion 103 of the body 100 can increase according to the rotation angle to realize 360-degrees detection. For example, when the body 100 rotates with the rotation angle of 120 degrees, the number of the third alarm detector 143 can be three, the three third alarm detector 143 can be coupled to the lateral portion 103 with equal intervals therebetween.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An aerial vehicle comprising:
a body;
a plurality of rotors coupled to the body and configured to provide lift;
a plurality of driving devices coupled to the rotors respectively, and configured to drive the rotors to rotate; and
a control device coupled to the body and the driving devices, the control device comprising a gyroscope and a controller, the gyroscope configured to collect information of rotation speed of the body and transmit the information of the rotation speed to the controller;
wherein, the controller is configured to provide a driving power for adjusting the rotation speed of the body according the information of the rotation speed and to produce and transmit a control signal of the driving power to the driving devices to output the driving power to corresponding rotors to adjust the rotation speed of the body.

2. The aerial vehicle of claim 1, wherein when the aerial vehicle is hovering, the body rotates.

3. The aerial vehicle of claim 2, wherein when the aerial vehicle is hovering, the rotation speed of the body is less than a rotation speed of the rotors.

4. The aerial vehicle of claim 2, wherein body rotates intermittently or with a preset rotation angle.

5. The aerial vehicle of claim 2, further comprising an alarm detection device coupled to the body.

6. The aerial vehicle of claim 5, wherein the alarm detection device comprises a plurality of alarm detectors coupled to the body.

7. The aerial vehicle of claim 6, wherein alarm detectors rotate following rotation of the body.

8. The aerial vehicle of claim 7, wherein the body comprises a ceiling portion, a bottom portion opposite to the ceiling portion and a lateral portion connecting the ceiling portion and the bottom portion, the alarm detection device comprising a first alarm detector coupled to the ceiling portion, a second alarm detector coupled to the bottom portion, and a third alarm detector coupled to the lateral portion.

9. The aerial vehicle of claim 2, wherein the rotors are divided to a first unit and a second unit, the rotors of the first unit rotate anticlockwise, the rotors of the second unit rotate clockwise, rotation speed of the rotors are adjusted by adjusting driving power output from corresponding driving devices to realize flight attitudes of level flight, level rotation, vertical flight, hovering of the aerial vehicle.

10. The aerial vehicle of claim 9, wherein the plurality of rotors comprise four rotors, the two rotors at a diagonal line are belong to the first unit, the other two rotors at another diagonal line are belong to the second unit.

11. The aerial vehicle of claim 2, wherein the control device further comprises an accelerator configured to measure accelerated velocity of the body in flight for stabling balance of the body, and a magnetic compass configured to measure geomagnetic angle for marking nose direction of the aerial vehicle.

12. The aerial vehicle of claim 2, further comprising a plurality of arms integrally extending outwards from the body.

13. The aerial vehicle of claim 12, wherein the driving devices are coupled to distal ends of corresponding arms.
